(19) United States
(12) Patent Application Publication
(10) Pub. No.: US 2025/0020526 A1
(43) Pub. Date: Jan. 16, 2025

(54) PRESSURE SENSOR WITH FROST COMPENSATOR

(71) Applicant: SSI Technologies, LLC, Janesville, WI (US)

(72) Inventors: Kathleen B. Arnold, Belvidere, IL (US); Mark Edward Kernien, Edgerton, WI (US)

(21) Appl. No.: 18/770,260

(22) Filed: Jul. 11, 2024

Related U.S. Application Data
(60) Provisional application No. 63/513,761, filed on Jul. 14, 2023.

(51) Int. Cl. G01L 9/00; G01L 19/00

(52) U.S. Cl. CPC G01L 9/008; G01L 19/0038

(57) ABSTRACT

A pressure sensor device includes an upper housing and a lower housing joined to the upper housing. The lower housing defines an inlet, a chamber, and a passageway extending between the inlet and the chamber. The lower housing is configured to receive a fluid. The pressure sensor device includes a sensor element affixed to the lower housing to prevent the fluid from exiting the chamber and the sensor element is configured to detect a pressure of the fluid. The pressure sensor device also includes a compensator assembly disposed in the chamber, the compensator assembly includes a holder, and a compressible clement positioned in the holder. The compressible element is sealed from the fluid.

### RELATED APPLICATIONS

This application claims the benefit of U.S. Provisional Patent Application No. 63/513,761, filed Jul. 14, 2023, the entire content of which is hereby incorporated by reference.

### BACKGROUND

Embodiments, examples, and aspects herein relate to, among other things, a pressure sensor device.

### SUMMARY

Most modern vehicles (for example, passenger vehicles, buses, and trucks) include various sensors for sensing physical phenomenon in or around the vehicle. In some examples, the sensors may include a pressure sensor to sense the pressure of a fluid in a vehicle system. In trucks, buses, and other vehicles with diesel engines, exhaust aftertreatment systems are used to reduce harmful emissions, for example, nitrogen-oxide (NOx) emissions. In many exhaust aftertreatment systems, diesel exhaust fluid (DEF), which is sometimes referred to as “urea,” is sprayed or injected into an exhaust stream and, along with a catalyst, converts NOx to nitrogen (N2) and water vapor (H2O). The DEF is pressurized to facilitate injection into the exhaust stream. Measuring the pressure of the DEF helps ensure that the system operates correctly and is important for purposes of controlling the amount of DEF injected into the exhaust stream.

As noted sometimes DEF is referred to, in a shorthand manner, as urea. More accurately, DEF is a solution of water and urea. Depending on the amount of urea in the DEF (e.g., the concentration of urea), DEF will freeze when its temperature drops. Typically, DEF freezes at 12 degrees Fahrenheit. As a water-based solution, DEF expands when it freezes, and the frozen DEF may adversely effect a pressure sensor. For example, frozen or partially frozen DEF may block or clog passageways in the sensor or may damage components of the sensor (for example, membranes in piezoelectric sensing elements). A clogged or damaged sensor will not operate properly and, as a consequence, the system that relies on information from the sensor (for example, an exhaust aftertreatment system) will not operate correctly. A condition when DEF fully or partially freezes is sometimes be referred to as a frost condition. Although described above with respect to exhaust gas aftertreatment systems and DEF, sensing the pressure of various fluids is important in a variety of vehicle system and other fields. In cases where the fluid freezes and expands, a pressure sensor (or pressure sensor device) with a frost compensation may have applicability. Thus, embodiments and examples provided are not limited to DEF or exhaust aftertreatment systems.

Examples described herein provide, among other things, a pressure sensor device that compensates for freezing of a sensed fluid (or frost conditions).

One example provides a pressure sensor device including an upper housing and a lower housing joined to the upper housing. The lower housing defines an inlet, a chamber, and a passageway extending between the inlet and the chamber. The lower housing is configured to receive a fluid. The pressure sensor device includes a sensor element affixed to the lower housing to prevent the fluid from exiting the chamber, the sensor element is configured to detect a pressure of the fluid. The pressure sensor device also includes a compensator assembly disposed in the chamber, the compensator assembly includes a holder and a compressible element positioned in the holder. The compressible element is sealed from the fluid.

In some instances, the sensor element is configured to be in contact with the fluid.

In some instances, the holder includes a spacer and a cap affixed to the spacer, wherein the compressible element is positioned between the spacer and the cap, and wherein the compressible element is sealed from the fluid in the passageway.

In some instances, the spacer includes a plurality of channels, and wherein the fluid is configured to flow through the plurality of channels.

In some instances, the cap includes a cap bead formed at a distal end of the cap, and wherein the cap bead is configured to abut the spacer to form a seal therebetween.

In some instances, a retainer is disposed in the chamber, and wherein the retainer is configured to retain the compensator assembly in the chamber.

In some instances, a seal component is positioned between the sensor element and the retainer, and wherein the seal component is configured to prevent the fluid from exiting the chamber.

In some instances, the holder includes a ring defining a ring cavity and a spool disposed in the ring cavity, and wherein the compressible element is disposed in the ring cavity between the spool and the ring.

In some instances, the spool includes a first rim including a first rim bead and a second rim including a second rim bead.

In some instances, the first rim bead abuts the ring to form a first seal therebetween, and wherein the second rim bead abuts the ring to form a second seal therebetween.

Another example provides a pressure sensor device including an upper housing and a lower housing joined to the upper housing. The lower housing defines an inlet, a chamber, and a passageway extending between the inlet and the chamber. The lower housing is configured to receive a fluid. The pressure sensor device includes a sensor element affixed to the lower housing to prevent the fluid from exiting the chamber. The sensor element is configured to detect a pressure of the fluid. The pressure sensor device also includes a compensator assembly disposed in the chamber, the compensator assembly includes a spacer, a cap affixed to the spacer, and a compressible element positioned between the spacer and the cap. The compressible element is sealed from the fluid.

Another example provides a pressure sensor device including an upper housing and a lower housing joined to the upper housing. The lower housing defines an inlet, a chamber, and a passageway extending between the inlet and the chamber. The lower housing is configured to receive a fluid. The pressure sensor device includes a sensor element affixed to the lower housing to prevent the fluid from exiting the chamber, the sensor element is configured to detect a pressure of the fluid. The pressure sensor device also includes a compensator assembly disposed in the chamber, the compensator assembly includes a ring defining a ring cavity, a spool positioned in the ring cavity, and a compressible element positioned in the ring cavity adjacent the spool. The compressible element is sealed from the fluid.

In some instances, the spool includes a duct extending between the first rim and the second rim, and wherein the duct fluidly connects with the passageway.

In some instances, the compressible element is positioned between the duct and the ring.

Other features, aspects, and benefits of various examples will become apparent by consideration of the detailed description and accompanying drawings.

### BRIEF DESCRIPTION OF THE DRAWINGS

FIG. 1 is a perspective view of a pressure sensor device according to some examples.

FIG. 2 is a side view of the pressure sensor device of FIG. 1.

FIG. 3 is a cross sectional view of the pressure sensor device of FIG. 1 taken along section line A-A of FIG. 2 and includes a compensator assembly according to one example.

FIG. 4 is an exploded view of the pressure sensor device of FIG. 3.

FIG. 5 is a perspective view of the pressure sensor device of FIG. 3 with an upper housing removed.

FIG. 6 is a perspective view of the pressure sensor device of FIG. 3 with an upper housing and a circuit board assembly removed.

FIG. 7 is a cross sectional view of the pressure sensor device of FIG. 6 taken along section line B-B of FIG. 6.

FIG. 8 is a detailed cross sectional view of the compensator assembly of the pressure sensor device of FIG. 7.

FIG. 9 is an exploded view of the compensator assembly of FIG. 7.

FIG. 10 is a bottom perspective view of the compensator assembly of FIG. 8 and a retainer according to one example.

FIG. 11 is another cross sectional view of the pressure sensor device of FIG. 6 taken along section line B-B of FIG. 6.

FIG. 12 is a cross sectional view of the pressure sensor device of FIG. 1 taken along section line A-A of FIG. 2 and includes a compensator assembly according to another example.

FIG. 13 is an exploded view of the pressure sensor device of FIG. 12.

FIG. 14 is a perspective view of the pressure sensor device of FIG. 12 with an upper housing and a circuit board assembly removed.

FIG. 15 is cross sectional view of the pressure sensor device of FIG. 14 taken along section line C-C of FIG. 14.

FIG. 16 is a detailed cross sectional view of the compensator assembly of FIG. 15.

FIG. 17 is an exploded view of the compensator assembly of FIG. 15.

FIG. 18 is another cross sectional view of the pressure sensor device of FIG. 14 taken along section line C-C of FIG. 14.

### DETAILED DESCRIPTION

One or more examples are described and illustrated in the following description and accompanying drawings. These examples are not limited to the specific details provided herein and may be modified in various ways. Other examples may exist that are not described herein. For example, a device or structure that is “configured” in a certain way is configured in at least that way but may also be configured in ways that are not listed.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections.

Unless the context of their usage unambiguously indicates otherwise, the articles “a” and “an” should not be interpreted as meaning “one” or “only one.” Rather these articles should be interpreted as meaning “at least one” or “one or more.”

Relational terms, for example, first and second, top and bottom, and the like may be used herein solely to distinguish one entity or action from another entity or action without necessarily requiring or implying any actual such relationship or order between such entities or actions.

In some examples, method steps or assembly steps are conducted in an order that is different from the order described.

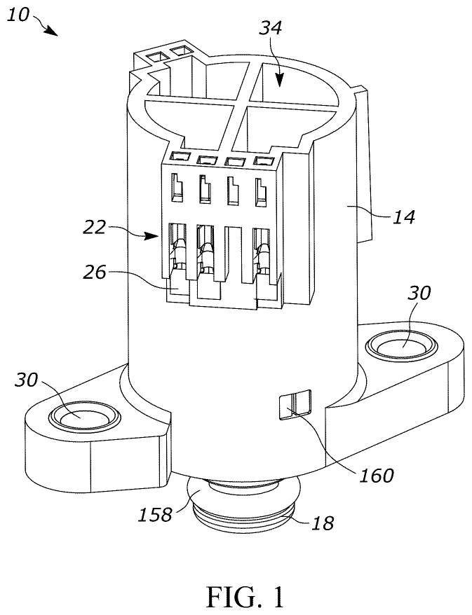

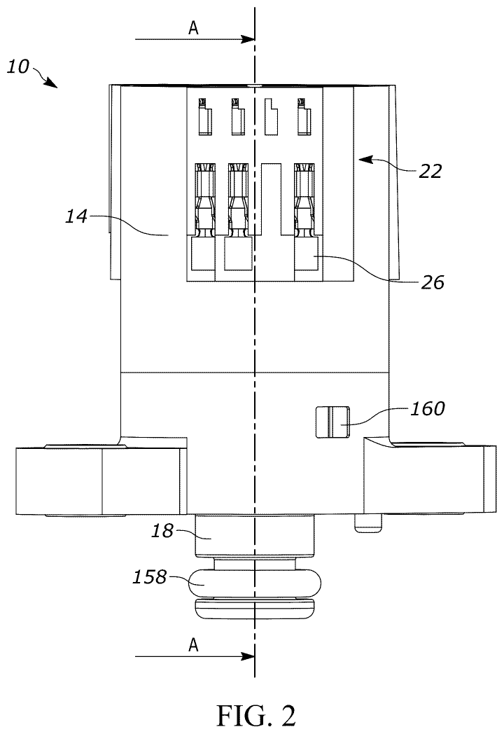

FIGS. 1 and 2 illustrate a pressure sensor device 10. In some examples, the pressure sensor device 10 is configured to measure a pressure of a fluid (e.g., diesel exhaust fluid) in a vehicle system. The pressure sensor device 10 includes an upper housing 14 and a lower housing 18 joined to the upper housing 14. The upper housing 14 includes an electrical interface 22 having a terminal 26 that is configured to interface and electrically connect to an outside system. In some cases, that outsides system is a vehicle electrical system or network (for example, a CAN bus) which may include or be connected to one or more computers to process signals from the pressure sensor device 10. The upper housing 14 defines a bolt aperture 30 configured to receive a bolt to mechanically connect the pressure sensor device 10 to the vehicle. In the illustrated example, the upper housing 14 defines two bolt apertures 30.

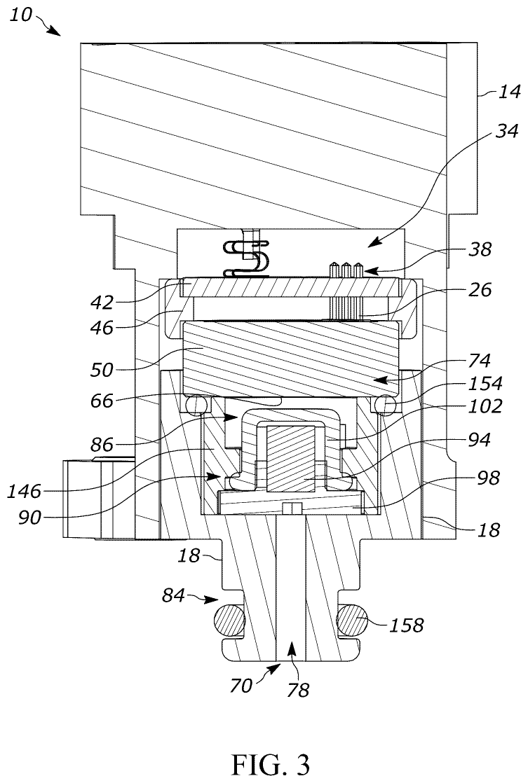

With reference to FIGS. 2 and 3, the upper housing 14 defines an internal cavity 34. The upper housing 14, and more specifically, the internal cavity 34 receives and supports a circuit board assembly 38 including a circuit board 42 and a circuit board spacer 46, a sensor element 50, and the lower housing 18. In some examples, the circuit board 42 may be a printed circuit board assembly (i.e., PCBA). In some examples, the circuit board 42 includes an integrated circuit with signal conditioning and processing functions. In other examples, the circuit board 42 includes a microcontroller, a microprocessor, an application specific integrated circuit (i.e., ASIC), or other device configured to provide operational control of the pressure sensor device 10. The circuit board 42 may supply power or communicate with the sensor element 50. For example, the circuit board 42 may receive signals from components of the pressure sensor device 10 to measure the pressure of the fluid in a vehicle system.

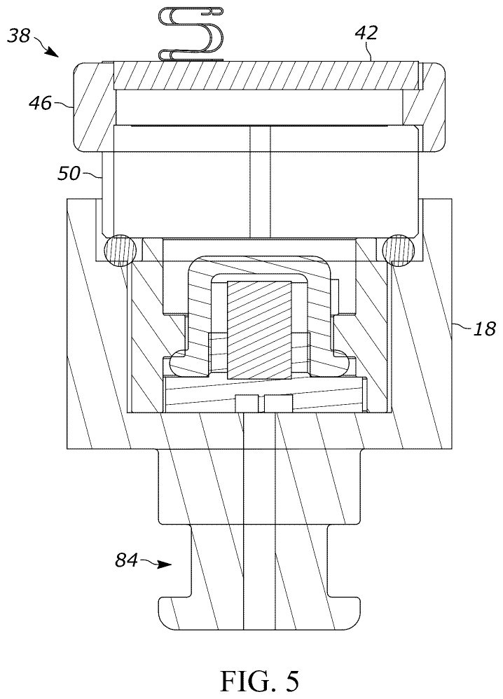

As shown in FIGS. 3 and 5, the circuit board 42 is disposed in the circuit board spacer 46. The circuit board 42 is positioned adjacent the sensor element 50. The circuit board 42 and the circuit board spacer 46 are positioned above and are supported by the sensor element 50. In other words, the circuit board 42 may be positioned atop the sensor element 50. The circuit board assembly 38 is affixed to the sensor element 50.

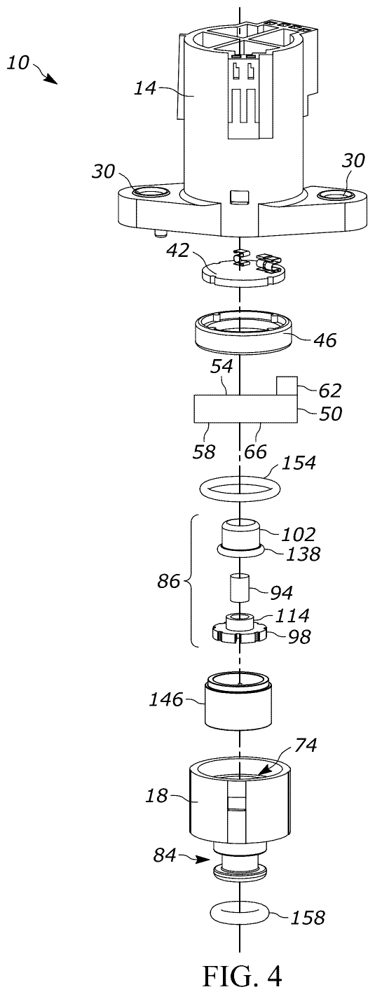

With reference to FIGS. 4 and 5, the sensor element 50 is affixed to the lower housing 18. The sensor element 50 is positioned between the circuit board 42 and the lower housing 18. One non-limiting sensor element 50 includes a pressure sensor element, for example, model number ME501/ME505 available from Metallux of Mendrisio, Switzerland. In the example illustrated, the sensor element 50 includes a solid body having a cylindrical shape. The sensor element 50 does not define a recess, an aperture, or cavity in the body.

As shown in FIG. 4, the sensor element 50 includes a first end face 54 and a second end face 58 opposite the first end face 54. The first end face 54 is configured to interface and electrically connect with the circuit board 42. In some examples, the first end face 54 of the sensor element 50 may include a terminal 62 configured to interface and electrically connect with the circuit board 42. The second end face 58 is in contact with the lower housing 18. The second end face 58 includes a diaphragm 66 configured to be in contact with a fluid. The diaphragm 66 may also be referred to as a membrane, a layer, or a detection element. The diaphragm 66 includes an electrical or electronic component that is able to output a signal dependent on the deformation or bending of the diaphragm 66. The electrical or electronic component may also be referred to as a thick-film piezo-resistive element. The sensor element 50 utilizes a piezoresistive principle to measure a pressure of a fluid in the pressure sensor device 10.

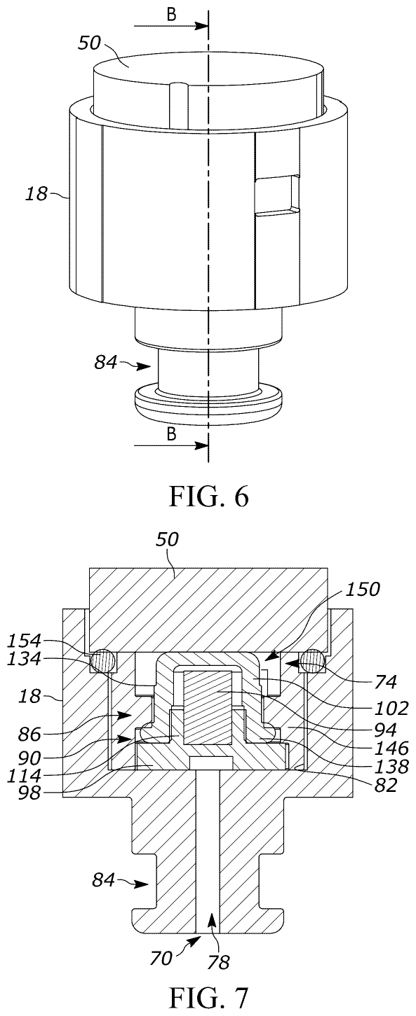

With reference to FIGS. 6 and 7, the lower housing 18 includes a cylindrical body. The lower housing 18 defines an inlet 70, a chamber 74, and a passageway 78 extending between inlet 70 and the chamber 74. In other words, the lower housing 18 includes an inner surface 82 that defines the inlet 70, the chamber 74, and the passageway 78. The chamber 74 may also be referred to as a pocket or a cavity. The chamber 74 includes a first diameter measured at the inner surface 82 of the lower housing 18. The passageway 78 includes a second diameter measured at the inner surface 82 of the lower housing 18. The first diameter is greater than the second diameter. In other words, the second diameter is less than the first diameter. The lower housing 18 also defines a channel 84 adjacent a distal end of the lower housing 18.

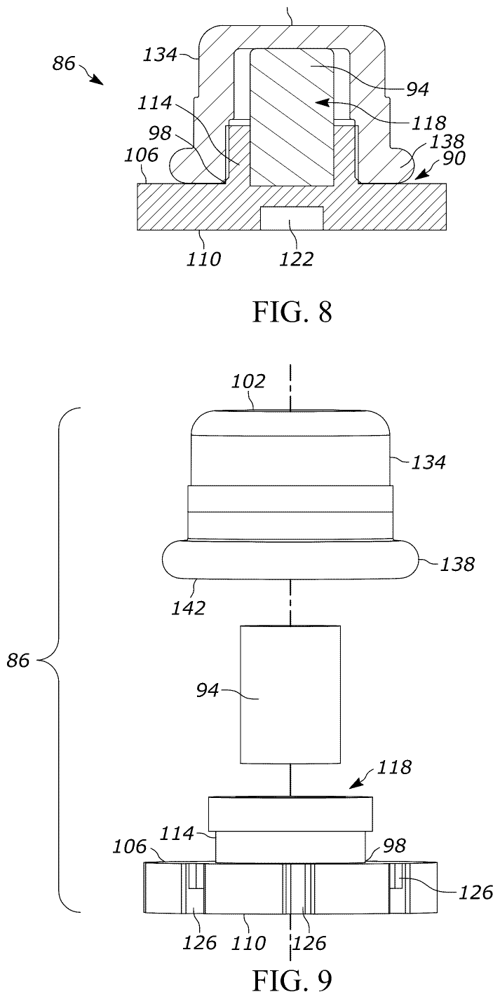

With reference to FIGS. 7 and 8, the pressure sensor device 10 includes a compensator assembly 86 according to some examples. The compensator assembly 86 is disposed in the chamber 74 of the lower housing 18. In some examples, the compensator assembly 86 may be a frost compensator for the pressure sensor device 10. The compensator assembly 86 provides a mechanism that compensates for the expansion of the fluid being measured when the fluid freezes. In simple terms, the compensator assembly 86 compresses or deforms when acted upon by the frozen fluid. The compensator assembly 86 helps to reduce or eliminate forces created by the expansion of the frozen fluid that in the absence of the compensator assembly 86 might otherwise act on elements in the pressure sensor device 10, for example the diaphragm 66. The compressible or deformable nature of the compensator assembly 86 (or its components) also provides an increase in volume available to the fluid when its volume expands due to freezing. In this way, the compensator assembly 86 helps prevent damages to components of the pressure sensor device 10 and helps to reduce blockage in the passageways of the pressure sensor device 10.

With reference to FIGS. 7 and 8, the compensator assembly 86 includes a holder 90 and a compressible element 94. The holder 90 may also be referred to as a receptacle, a container, or a vessel. The holder 90 is configured to hold or retain the compressible element 94 in the holder 90. The holder 90 may be formed from a plastic, a rubber, or polymer material.

As shown in FIGS. 8 and 9, the compressible element 94 is positioned in the holder 90. The compressible element 94 is sealed within the holder 90. The compressible element 94 may be formed from a spongy or foamed material such as an impermeable material with closed cell. In some examples, the compressible element 94 may be formed from a silicone or ethylene propylene diene monomer (i.e., EPDM) material. In these examples, the EPDM material is a synthetic rubber made up of ethylene, propylene, and diene monomers.

With continued reference to FIGS. 8 and 9, in some examples, the holder 90 includes a spacer 98 and a cap 102. The spacer 98 includes a first face 106 and a second face 110 opposite the first face 106. A cylindrical rim 114 extends from the first face 106. The cylindrical rim 114 defines a recess 118 for receiving the compressible element 94. The spacer 98 may be formed from a polymer or plastic material.

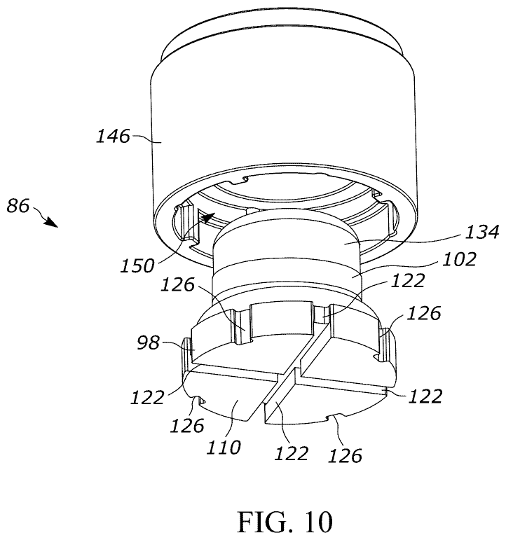

As shown in FIGS. 9 and 10, the spacer 98 defines a plurality of channels 122. More specifically, the second face 110 of the spacer 98 defines the plurality of channels 122. The plurality of channels 122 extend across the second face 110 of the spacer 98. The plurality of channels 122 are configured to receive a fluid and allow the fluid to flow from the passageway 78 to the chamber 74 of the lower housing 18. In the illustrated example, the second face 110 of the spacer 98 defines four channels 122. In other examples, the second face 110 of the spacer 98 may define any number of channels 122 (e.g., one, two, three, four, or five). The spacer 98 may also include additional channels 126 arranged around an outer perimeter of the spacer 98. The additional channels 126 extend between the second face 110 and the first face 106. The additional channels 126 allow for fluid to flow from the passageway 78 to the chamber 74 of the lower housing 18. In the illustrated example, the spacer 98 defines four additional channels 126. In other examples, the spacer 98 may define any number of additional channels 126 (e.g., one, two, three, four, or five).

As shown in FIGS. 8 and 9, the cap 102 includes a cylindrical shape. The cap 102 may be formed from a polymer or rubber material. The cap 102 includes a cap sidewall 134 and a cap bead 138 at a distal end 142 of the cap 102. The cap bead 138 may also be referred to as a cap ring. The cap bead 138 may be formed as a thickened portion, where a thickness of the cap 102 is greater than remainder of the cap 102. The cap bead 138 is configured to abut the spacer 98 to form a seal therebetween.

With reference to FIGS. 7 and 10, the pressure sensor device 10 also includes a retainer 146. The retainer 146 may be disposed in the chamber 74 of the lower housing 18. The retainer 146 may be formed from a polymer or plastic material. The retainer 146 defines a retainer cavity 150 configured to receive the compensator assembly 86. The retainer 146 is configured to retain or hold the compensator assembly 86 in the chamber 74 of the lower housing 18.

With continued reference to FIG. 7, the pressure sensor device 10 also includes a seal component 154. The seal component 154 is positioned between the sensor element 50 and the retainer 146. The seal component 154 may be formed from a polymer or rubber material. The seal component 154 is configured to seal the fluid within the chamber 74. In other words, the seal component 154 is configured to prevent fluid from exiting the chamber 74. In the illustrated example, the seal component 154 is an O-ring. In other examples, the seal component 154 may be any suitable seal component 154 configured to seal the fluid within the chamber 74 or prevent fluid from exiting the chamber 74.

In the illustrated example and with reference to FIGS. 8 and 9, the compensator assembly 86 is assembled by affixing the compressible element 94 in the spacer 98. In particular, affixing the compressible element 94 in the recess 118 of the spacer 98. The cap 102 is affixed to the spacer 98 such that the cap bead 138 abuts the spacer 98. More specifically, the cap bead 138 abuts the first face 106 of the spacer 98 and the retainer 146 to form a seal therebetween. The assembled compensator assembly 86 is coupled to the retainer 146 and then disposed in the chamber 74 of the lower housing 18. The seal component 154 is positioned in the chamber 74 of the lower housing 18 between the inner surface 82 of the lower housing 18 and the retainer 146. The sensor element 50 is affixed to the lower housing 18 to seal the chamber 74 of the lower housing 18. The seal component 154 abuts the sensor element 50, the inner surface 82 of the lower housing 18, and the retainer 146 to form a seal therebetween.

Referring back to FIGS. 3 and 5, the circuit board assembly 38 including the circuit board 42 and the circuit board spacer 46 is affixed to the assembled lower housing 18. The assembled lower housing 18 and assembled circuit board assembly 38 are disposed in the internal cavity 34 of the upper housing 14. In some examples, the upper housing 14 and the lower housing 18 may include corresponding interlocking geometry. Referring back to FIG. 1, the pressure sensor device 10 includes a pin 160 to join the lower housing 18 to the upper housing 14. A second seal component 158 is disposed in the channel 84 of the lower housing 18 (FIGS. 1 and 2). The assembled pressure sensor device 10 is secured to the vehicle using the bolt inserted through the bolt aperture 30.

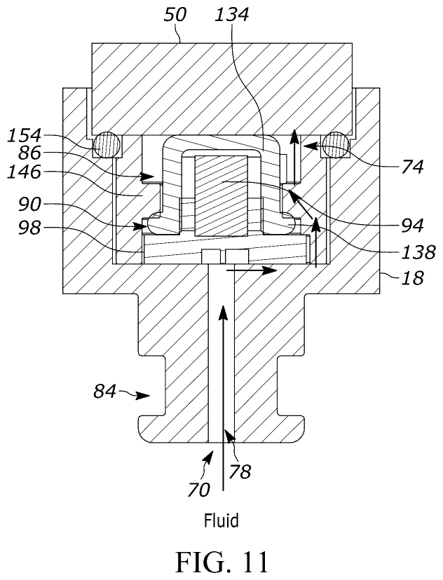

Moving ahead in the figures and with reference to FIG. 11, the pressure sensor device 10 is configured to measure a pressure of a fluid (e.g., diesel exhaust fluid). In the illustrated example, the fluid enters the lower housing 18. More specifically, the fluid enters the inlet 70, flows through the passageway 78, and flows into the chamber 74 to contact the sensor element 50. In other words, the fluid enters the inlet 70, flows through the passageway 78, flows through the plurality of channels 122 and/or the additional channels 126 of the spacer 98, and flows into the chamber 74 to contact the sensor element 50. The fluid does not contact the compressible element 94. The fluid contacts the diaphragm 66 of the sensor element 50 to impart a force or pressure on the diaphragm 66. The diaphragm 66 of the sensor element 50 deforms or bends in response to the fluid. The sensor element 50 includes an electrical or electronic component that outputs a signal dependent on the deformation or bending of the diaphragm 66. The signal is then utilized to determine the pressure of the fluid in a vehicle system.

The pressure sensor device 10 provides a number of advantages over prior art pressure sensor devices. As an example advantage, the pressure sensor device 10 includes the compensator assembly 86 that compensates for freezing of the fluid, as noted above. The compensator assembly 86 is disposed in the chamber 74 of the lower housing 18, where the compensator assembly 86 is in a direction of the fluid flowing through the pressure sensor device 10. The compensator assembly 86 also includes the compressible element 94 that is sealed from the fluid in the chamber 74 of the lower housing 18. In other words, the compressible element 94 does not contact the fluid in chamber 74 of the lower housing 18. The compressible element 94 is also separated from sensor element 50 (i.e., does not contact the sensor element 50). The pressure sensor device 10 is less likely to be damaged and to operate correctly when operated in cold temperatures, for example, 12 degrees Fahrenheit or less.

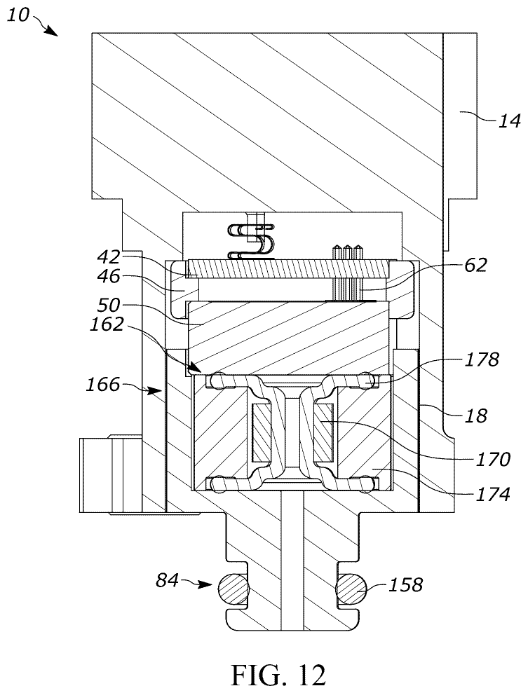

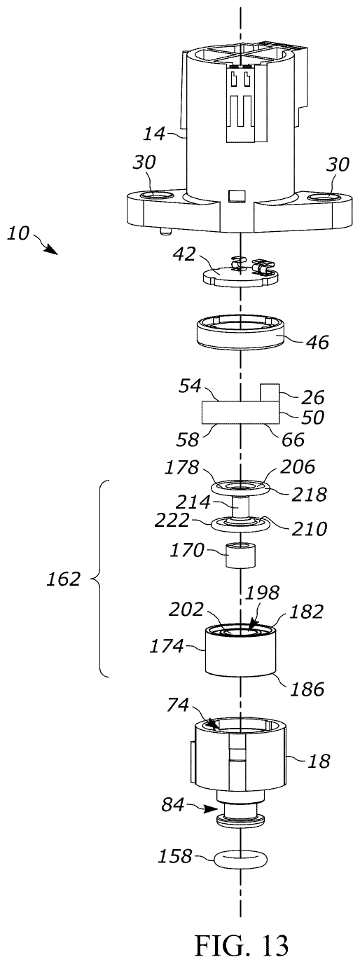

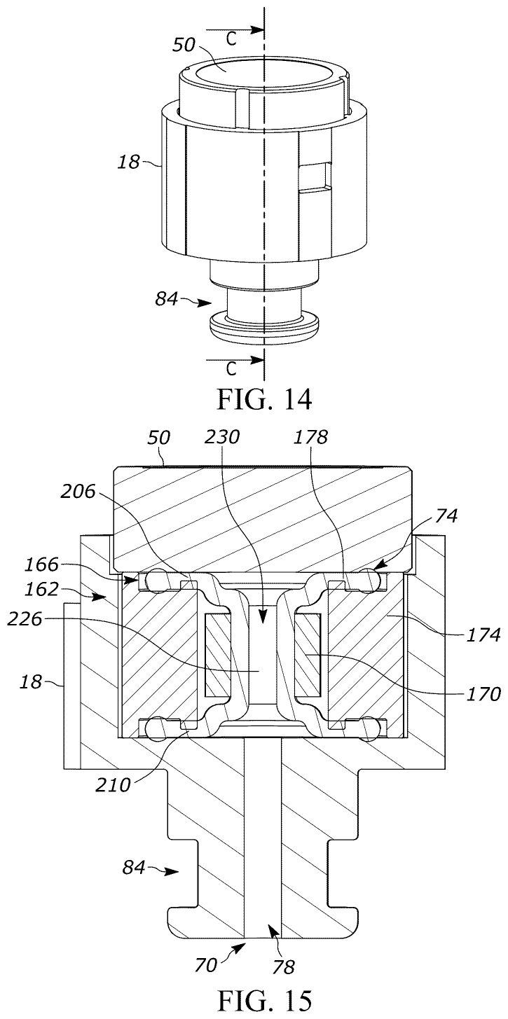

FIGS. 12 and 13 illustrate the pressure sensor device 10 including a compensator assembly 162 according to some examples. The compensator assembly 162 may be disposed in the chamber 74 of the lower housing 18 (FIGS. 14 and 15). In some examples, the compensator assembly 162 may be a frost compensator for the pressure sensor device 10. The compensator assembly 162 provides the benefits mentioned above when the fluid freezes.

With reference to FIG. 13, the compensator assembly 162 includes a holder 166 and a compressible element 170. The holder 166 may also be referred to as a receptacle, a container, or a vessel. The holder 166 is configured to hold or retain the compressible element 170 within the holder 166. The holder 166 may be formed from a plastic, a rubber, or polymer material.

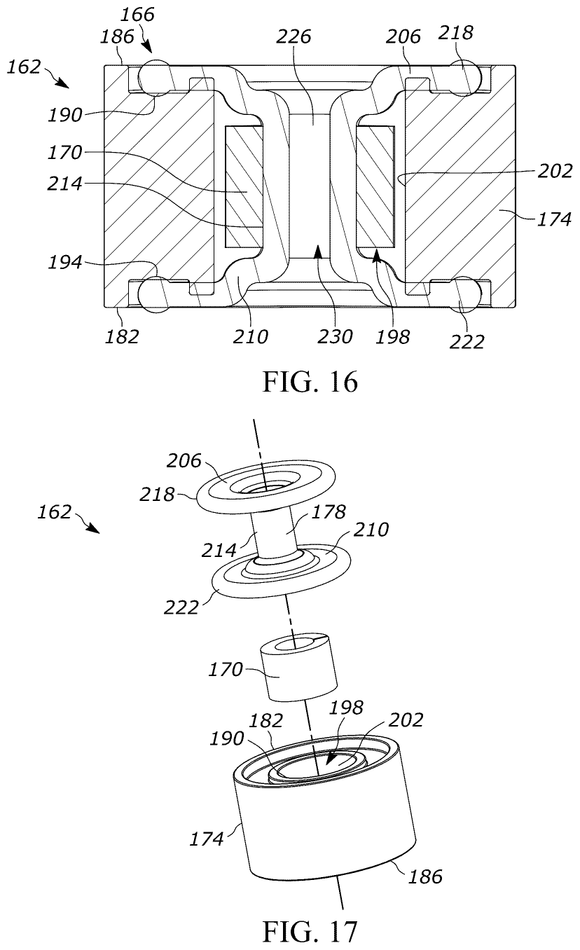

As shown in FIGS. 15 and 16, the compressible element 170 is positioned in the holder 166. The compressible element 170 is sealed within the holder 166. The compressible element 170 may be formed from a spongy or foamed material such as an impermeable material with closed cell. In some examples, the compressible element 170 may be formed from a silicone or ethylene propylene diene monomer (i.e., EPDM) material. In these examples, the EPDM material is a synthetic rubber made up of ethylene, propylene, and diene monomers.

With reference to FIGS. 16 and 17, in some examples, the holder 166 includes a ring 174 and a spool 178. The ring 174 may be formed a polymer, rubber, or elastic material. The ring 174 includes a cylindrical shape. The ring 174 includes a first end 182 and a second end 186 opposite the first end 182. The ring 174 defines a first indentation 190 recessed relative the first end 182, and a second indentation 194 recessed relative to the second end 186. The ring 174 defines a ring cavity 198 extending between the first end 182 and the second end 186. More specifically, an inner surface 202 of the ring 174 defines the ring cavity 198.

With continued reference to FIGS. 16 and 17, the spool 178 may be formed from a polymer, rubber, or elastic material. In some examples, the spool 178 and the ring 174 may be formed from the same material. In other examples, the spool 178 and the ring 174 may be formed from different materials. The spool 178 includes a first rim 206, a second rim 210, and a duct 214 extending between the first rim 206 and the second rim 210.

The first rim 206 includes a circular shape having a first rim diameter. The first rim 206 includes a first rim bead 218 positioned on an outer perimeter of the first rim 206. The first rim bead 218 may also be referred to as a first rim ring. The first rim bead 218 may be formed as a thickened portion, where a thickness of the first rim bead 218 is greater than the remainder of the first rim 206. The first rim bead 218 is configured to abut the inner surface 202 of the ring 174.

As shown in FIGS. 16 and 17, the second rim 210 includes a circular shape having a second rim diameter. The second rim 210 includes a second rim bead 222 positioned on an outer perimeter of the second rim 210. The second rim bead 222 may also be referred to as a second rim ring. The second rim bead 222 may be formed as a thickened portion, where a thickness of the second rim bead 222 is greater than the remainder of the second rim 210. The second rim bead 222 is configured to abut the inner surface 202 of the ring 174. In some examples, the second rim bead 222 may be the same as the first rim bead 218 (e.g., in terms of shape, size, thickness, etc.). In other examples, the second rim bead 222 may be different than the first rim bead 218 (e.g., in terms of shape, size, thickness, etc.).

With continued reference to FIGS. 16 and 17, the duct 214 includes a cylindrical shape having a duct diameter. The duct diameter is smaller than the first rim diameter and the second rim diameter. The duct 214 defines a duct cavity 226 extending between the first rim 206 and the second rim 210. The duct cavity 226 forms a passageway 230 extending through the spool 178 between the first rim 206 and the second rim 210. The duct cavity 226 is in fluid communication with the passageway 78 of the lower housing 18 when the pressure sensor device 10 is assembled.

In the illustrated example, with reference to FIGS. 15 and 16, the compensator assembly 162 is assembled by joining the compressible element 170 to the spool 178. More specifically, the compressible element 170 is joined to the duct 214 of spool 178. The compressible element 170 and the spool 178 are disposed in the ring cavity 198 of the ring 174. The first rim 206 of the spool 178 abuts the inner surface 202 of the ring 174, and the second rim 210 of the spool 178 abuts the inner surface 202 of the ring 174. More specifically, the first rim bead 218 abuts the first indentation 190 of the ring 174 to form a first seal therebetween, and the second rim bead 222 abuts the second indentation 194 of the ring 174 to form a second seal therebetween. The compressible element 170 is positioned between the spool 178 and the ring 174. More specifically, the compressible element 170 is positioned between the duct 214 of the spool 178 and the inner surface 202 of the ring 174. The assembled compensator assembly 162 including the compressible element 170, the spool 178, and the ring 174 is disposed in the chamber 74 of the lower housing 18. The sensor element 50 is affixed to the lower housing 18 to seal the chamber 74 of the lower housing 18. The sensor element 50 abuts the ring 174 and the spool 178 to form a third seal therebetween to prevent fluid from exiting the chamber 74 of the lower housing 18. Affixing the compensator assembly 162 to the circuit board assembly 38 and the upper housing 14 is the same as described above for compensator assembly 86.

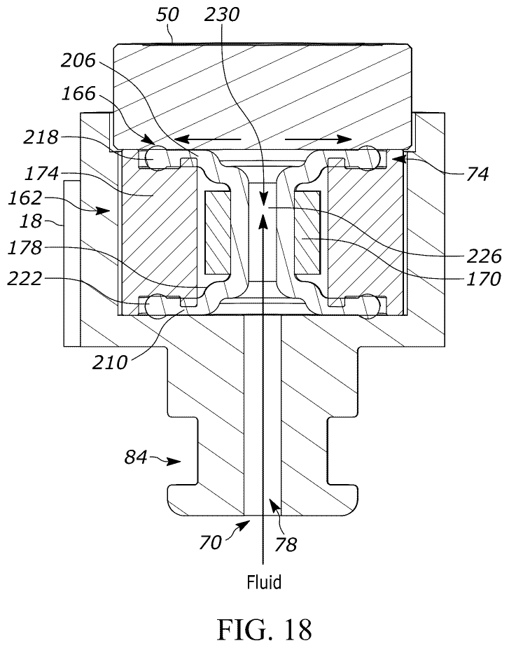

With reference to FIG. 18, the pressure sensor device 10 including the compensator assembly 162 is configured to measure a pressure of a fluid (e.g., diesel exhaust fluid). In the illustrated example, the fluid enters the lower housing 18. More specifically, the fluid enters the inlet 70 of the lower housing 18, flows through the passageway 78, and flows into the chamber 74 to contact the sensor element 50. More specifically, the fluid flows through the passageway 78, flows through the duct cavity 226 having the passageway 230, and into the chamber 74 to contact the sensor element 50. The duct cavity 226 of the spool 178, and in particular the passageway 230 of the spool 178 is in fluid communication with the passageway 78 of the lower housing 18. The sensor element 50 prevents the fluid from exiting the chamber 74 of the lower housing 18. The fluid contacts the diaphragm 66 of the sensor element 50 to impart a force or pressure on the diaphragm 66. The diaphragm 66 of the sensor element 50 deforms or bends in response to the fluid. The sensor element 50 includes an electrical or electronic component that outputs a signal dependent on the deformation or bending of the diaphragm 66. The signal is then utilized to determine the pressure of the fluid. The advantages described above in reference to the compensator assembly 86 including the holder 90 and the compressible element 94 also result from the compensator assembly 162 including the holder 166 and the compressible element 170.

Thus, examples provide, among other things, a pressure sensor having a frost compensator. Various features, advantages, and examples are set forth in the following claims.

What is claimed is:

1. A pressure sensor device comprising:
an upper housing;
a lower housing joined to the upper housing, the lower housing defining an inlet, a chamber, and a passageway extending between the inlet and the chamber, wherein the lower housing is configured to receive a fluid;
a sensor element affixed to the lower housing to prevent the fluid from exiting the chamber, the sensor element is configured to detect a pressure of the fluid; and
a compensator assembly disposed in the chamber, the compensator assembly including:
a holder, and
a compressible element positioned in the holder, the compressible element is sealed from the fluid.

2. The pressure sensor device of claim 1, wherein the sensor element is configured to be in contact with the fluid.

3. The pressure sensor device of claim 1, wherein the holder includes a spacer and a cap affixed to the spacer, wherein the compressible element is positioned between the spacer and the cap, and wherein the compressible element is sealed from the fluid in the passageway.

4. The pressure sensor device of claim 3, wherein the spacer includes a plurality of channels, and wherein the fluid is configured to flow through the plurality of channels.

5. The pressure sensor device of claim 3, wherein the cap includes a cap bead formed at a distal end of the cap, and wherein the cap bead is configured to abut the spacer to form a seal therebetween.

6. The pressure sensor device of claim 3, further including a retainer disposed in the chamber, and wherein the retainer is configured to retain the compensator assembly in the chamber.

7. The pressure sensor device of claim 6, further including a seal component positioned between the sensor element and the retainer, and wherein the seal component is configured to prevent the fluid from exiting the chamber.

8. The pressure sensor device of claim 1, wherein the holder includes a ring defining a ring cavity and a spool disposed in the ring cavity, and wherein the compressible element is disposed in the ring cavity between the spool and the ring.

9. The pressure sensor device of claim 8, wherein the spool includes a first rim including a first rim bead and a second rim including a second rim bead.

10. The pressure sensor device of claim 9, wherein the first rim bead abuts the ring to form a first seal therebetween, and wherein the second rim bead abuts the ring to form a second seal therebetween.

11. A pressure sensor device comprising:
an upper housing;
a lower housing joined to the upper housing, the lower housing defining an inlet, a chamber, and a passageway extending between the inlet and the chamber, wherein the lower housing is configured to receive a fluid;
a sensor element affixed to the lower housing to prevent the fluid from exiting the chamber, the sensor element is configured to detect a pressure of the fluid; and
a compensator assembly disposed in the chamber, the compensator assembly including:
a spacer,
a cap affixed to the spacer, and
a compressible element positioned between the spacer and the cap, the compressible element is sealed from the fluid.

12. The pressure sensor device of claim 11, wherein the spacer includes a plurality of channels, and wherein the fluid is configured to flow through the plurality of channels.

13. The pressure sensor device of claim 11, wherein the cap includes a cap bead formed at a distal end of the cap, wherein the cap bead is configured to abut the spacer to form a seal therebetween.

14. The pressure sensor device of claim 11, further includes a retainer disposed in the chamber, and wherein the retainer is configured to retain the compensator assembly in the chamber.

15. The pressure sensor device of claim 14, further includes a seal component positioned between the sensor element and the retainer, and wherein the seal component is configured to prevent the fluid from exiting the chamber.

16. A pressure sensor device comprising:
an upper housing;
a lower housing joined to the upper housing, the lower housing defining an inlet, a chamber, and a passageway extending between the inlet and the chamber, wherein the lower housing is configured to receive a fluid;
a sensor element affixed to the lower housing to prevent the fluid from exiting the chamber, the sensor element is configured to detect a pressure of the fluid; and
a compensator assembly disposed in the chamber, the compensator assembly including:
a ring defining a ring cavity,
a spool positioned in the ring cavity, and
a compressible element positioned in the ring cavity adjacent the spool, the compressible element is sealed from the fluid.

17. The pressure sensor device of claim 16, wherein the spool includes a first rim including a first rim bead and a second rim including a second rim bead.

18. The pressure sensor device of claim 17, wherein the first rim bead abuts the ring to form a first seal therebetween, and wherein the second rim bead abuts the ring to form a second seal therebetween.

19. The pressure sensor device of claim 17, wherein the spool includes a duct extending between the first rim and the second rim, and wherein the duct fluidly connects with the passageway.

20. The pressure sensor device of claim 19, wherein the compressible element is positioned between the duct and the ring.
